(19) United States
(12) Patent Application Publication
(10) Pub. No.: US 2021/0173957 A1
(43) Pub. Date: Jun. 10, 2021

(54) ENCRYPTED TAG GENERATION DEVICE, SEARCH QUERY GENERATION DEVICE, AND SEARCHABLE ENCRYPTION SYSTEM

(71) Applicant: Mitsubishi Electric Corporation, Tokyo (JP)

(72) Inventors: Yutaka KAWAI, Tokyo (JP); Yoshihiro KOSEKI, Tokyo (JP)

(73) Assignee: Mitsubishi Electric Corporation, Tokyo (JP)

(21) Appl. No.: 16/346,336

(22) PCT Filed: Jan. 12, 2017
(86) PCT No.: PCT/JP2017/000886

§ 371 Date: Apr. 30, 2019

(51) Int. Cl. G06F 21/62; G06F 21/60; G06F 16/903; G06F 17/16

(52) U.S. Cl. CPC G06F 21/6227; G06F 17/16; G06F 16/903; G06F 21/602

(57) ABSTRACT

In an encrypted tag generation device (40), a core tag generation unit (412) encrypts a range condition x\vec{ } indicating a range to permit searching, with a tag generation key tk, to generate a core tag c\tilde{ }ₓ, which is a vector over a basis B. An encrypted tag generation unit (413) generates an encrypted tag c_{x, w} in which a keyword w1 is set, by converting the core tag c\tilde{ }ₓ generated by the core tag generation unit (412), by encode information EW1 in which the keyword w1 for searching is encoded.

### TECHNICAL FIELD

The present invention relates to a searchable encryption technique capable of searching on data in an encrypted state.

### BACKGROUND ART

In recent years, there are cloud computing technologies that execute and provide various services by using computing resources in networks, particularly in the Internet. As these services, it is conceivable a service in which various kinds of data are stored in the network, and only a searcher permitted to use the data downloads and uses the data.

However, there are cases where there is data that needs to be kept secret so as not to be leaked to a third party, such as personal information of a user, among the data stored in the network. It is known that such data can be kept secret by encryption such as secret key encryption and public key encryption.

By placing encrypted data in the network in this way, it is possible to achieve both concealment of data and utilization of cloud computing. However, there is a problem that data can no longer be searched on after being encrypted. As a technique for solving this problem, there is a searchable encryption technique. In the searchable encryption technique, data in an encrypted state can be searched on by using a special encryption method.

In such searchable encryption technique, it is important that information is not leaked from data stored in the cloud. In addition, it is also important that information such as a keyword to be searched for be not leaked from a search query to be transmitted in searching.

Patent Literature 1 and Non Patent Literature 1 describe a method of sharing a same key between a user who registers encrypted data and a user who executes searching, and using encryption technique called predicate encryption for inner products. This realizes, in Patent Literature 1 and Non Patent Literature 1, a method in which no keyword to be searched for is leaked in searching.

In addition, Patent Literature 1 describes a method capable of cryptographically including access control for controlling which encrypted data may be accessed for each user.

Non Patent Literature 2 describes a method of realizing efficient searching without leakage of any keyword, by sharing a same key between a user who registers encrypted data and a user who executes searching.

### CITATION LIST

### Patent Literature

Patent Literature 1: WO 2015/184894 A

### Non Patent Literature

Non Patent Literature 1: Emily Shen, Elaine Shi, and Brent Waters. Predicate privacy in encryption systems. In TCC 2009, volume 5444 of LNCS, pages 457-473. Springer, 2009.

Non Patent Literature 2: D. Boneh, G. D. Crescenzo, R. Ostrovsky, and G. Persian. Public-Key Encryption with Keyword Search. In Advances in Cryptology—Eurocrypt, volume 3027 of LNCS, pages 506-522. Springer, 2004.

### SUMMARY OF INVENTION

### Technical Problem

In the methods described in Patent Literature 1 and Non Patent Literature 1, the number of times of executing a pairing operation used in searching is large, and a search speed is delayed. With the method described in Non Patent Literature 2, access control similar to the one in the method described in Patent Literature 1 cannot be realized.

It is an object of the present invention to enable increase of a search speed while realizing flexible access control.

### Solution to Problem

An encrypted tag generation device according to the present invention includes:

a core tag generation unit to generate a core tag by encrypting a range condition indicating a range to permit searching; and

an encrypted tag generation unit to generate an encrypted tag in which a keyword for searching is set, by converting the core tag generated by the core tag generation unit with use of encode information in which the keyword is encoded.

### Advantageous Effects of Invention

In the present invention, an encrypted tag is generated by converting a core tag obtained by encrypting a range condition, with use of encode information in which a keyword is encoded. This enables reduction of the number of elements included in the encrypted tag, and enables increase of a search speed. In addition, a range condition is also set for the encrypted tag, so that flexible access control can be realized.

### BRIEF DESCRIPTION OF DRAWINGS

FIG. 1 is a configuration diagram of a searchable encryption system 10 according to a first embodiment.

FIG. 2 is a configuration diagram of a master key generation device 20 according to the first embodiment.

FIG. 3 is a configuration diagram of a user key generation device 30 according to the first embodiment.

FIG. 4 is a configuration diagram of an encrypted tag generation device 40 according to the first embodiment.

FIG. 5 is a configuration diagram of a search query generation device 50 according to the first embodiment.

FIG. 6 is a configuration diagram of a search device 60 according to the first embodiment.

FIG. 7 is a flowchart illustrating an operation of the master key generation device 20 according to the first embodiment.

FIG. 8 is a flowchart illustrating an operation of the user key generation device 30 according to the first embodiment.

FIG. 9 is a flowchart illustrating an operation of the encrypted tag generation device 40 according to the first embodiment.

FIG. 10 is a flowchart illustrating an operation of the search query generation device 50 according to the first embodiment.

FIG. 11 is a flowchart illustrating an operation of the search device 60 according to the first embodiment, and is a flowchart illustrating an encrypted tag storage process.

FIG. 12 is a flowchart illustrating an operation of the search device 60 according to the first embodiment, and is a flowchart illustrating an encrypted tag search process.

FIG. 13 is a configuration diagram of a master key generation device 20 according to Modification 1.

FIG. 14 is a configuration diagram of a user key generation device 30 according to Modification 1.

FIG. 15 is a configuration diagram of an encrypted tag generation device 40 according to Modification 1.

FIG. 16 is a configuration diagram of a search query generation device 50 according to Modification 1.

FIG. 17 is a configuration diagram of a search device 60 according to Modification 1.

### DESCRIPTION OF EMBODIMENTS

### First Embodiment

### ***Description of Notation***

When A is a random variable value or distribution, Formula 11 represents random selection of y from A in accordance with distribution of A. That is, y is a random number in Formula 11.

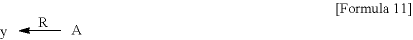

Formula 12 represents that y is a set defined by z, or that y is a set substituted for by z.

y:=z [Formula 12]

When a is a constant, Formula 13 represents that a machine (algorithm) A outputs a for an input x.

A(x)→a [Formula 13]

For a basis B and a basis B* represented in Formula 14, Formula 15 holds.

[symbol]

:=(b₁, . . . , b_{N}),

[symbol]

*:=(b*₁, . . . , b*_{N}) [Formula 14]

(x₁, . . . , x_{N} [symbol] :=Σᵢ₌₁^{N}xᵢbᵢ,

(y₁, . . . , y_{N} [symbol] :=Σᵢ₌₁^{N}yᵢb*ᵢ [Formula 15]

F_{q} indicates a finite field of an order q. Further, y ∈ F_{q}^{Z} indicates that y is a vector having z elements over the finite field F_{q}. Further, y ∈ F_{q}^{Z×W} indicates that y is a matrix of Z rows and W columns with elements over the finite field F_{q}.

***Description of Configuration***

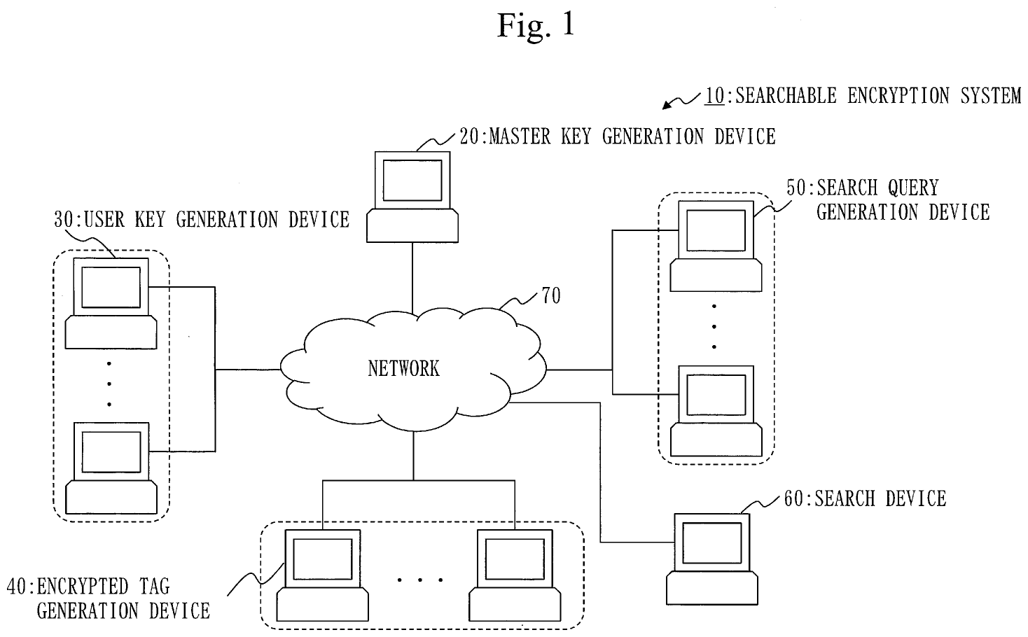

With reference to FIG. 1, a configuration of a searchable encryption system 10 according to a first embodiment will be described.

The searchable encryption system 10 includes a master key generation device 20, one or more user key generation device 30, one or more encrypted tag generation devices 40, one or more search query generation devices 50, and a search device 60.

The master key generation device 20, each user key generation device 30, each encrypted tag generation device 40, each search query generation device 50, and the search device 60 are connected via a network 70 such as the Internet. The network 70 is not limited to the Internet, but may be another type of network such as a local area network (LAN). The network 70 is a communication path between the master key generation device 20, each user key generation device 30, each encrypted tag generation device 40, each search query generation device 50, and the search device 60.

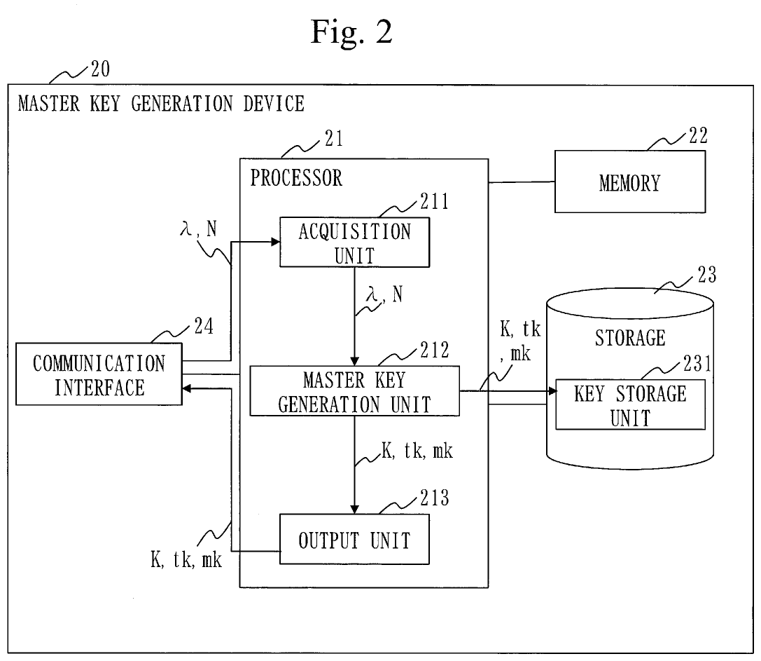

With reference to FIG. 2, a configuration of the master key generation device 20 according to the first embodiment will be described.

The master key generation device 20 is a computer.

The master key generation device 20 includes hardware of a processor 21, a memory 22, a storage 23, and a communication interface 24. The processor 21 is connected to other pieces of hardware via a signal line, and controls these other pieces of hardware.

The master key generation device 20 includes an acquisition unit 211, a master key generation unit 212, and an output unit 213, as functional components. Functions of the acquisition unit 211, the master key generation unit 212, and the output unit 213 are realized by software.

The storage 23 stores a program for realizing functions of the acquisition unit 211, the master key generation unit 212, and the output unit 213. This program is read into the memory 22 by the processor 21 and executed by the processor 21. Thus, functions of the acquisition unit 211, the acquisition unit 211, the master key generation unit 212, and the output unit 213 are realized.

In addition, the storage 23 realizes a function of a key storage unit 231.

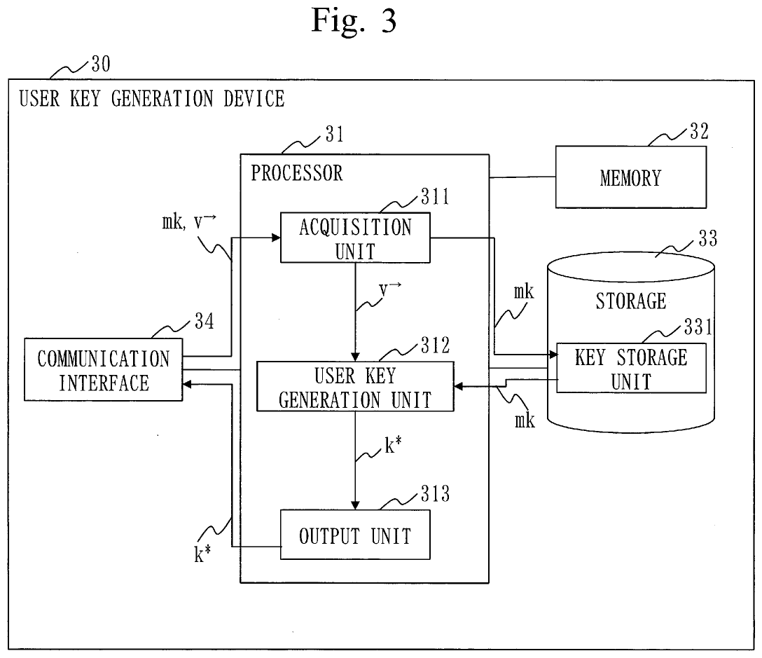

With reference to FIG. 3, a configuration of the user key generation device 30 according to the first embodiment will be described.

The user key generation device 30 is a computer.

The user key generation device 30 includes hardware of a processor 31, a memory 32, a storage 33, and a communication interface 34. The processor 31 is connected to other pieces of hardware via a signal line, and controls these other pieces of hardware.

The user key generation device 30 includes an acquisition unit 311, a user key generation unit 312, and an output unit 313, as functional components. Functions of the acquisition unit 311, the user key generation unit 312, and the output unit 313 are realized by software.

The storage 33 stores a program for realizing functions of the acquisition unit 311, the user key generation unit 312, and the output unit 313. This program is read into the memory 32 by the processor 31 and executed by the processor 31. Thus, functions of the acquisition unit 311, the user key generation unit 312, and the output unit 313 are realized.

In addition, the storage 33 realizes a function of a key storage unit 331.

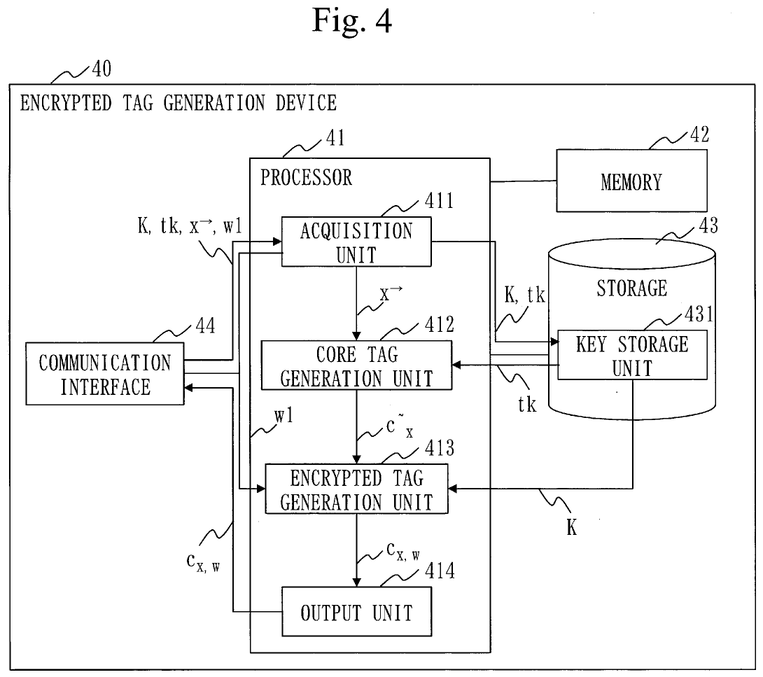

With reference to FIG. 4, a configuration of the encrypted tag generation device 40 according to the first embodiment will be described.

The encrypted tag generation device 40 is a computer.

The encrypted tag generation device 40 includes hardware of a processor 41, a memory 42, a storage 43, and a communication interface 44. The processor 41 is connected to other pieces of hardware via a signal line, and controls these other pieces of hardware.

The encrypted tag generation device 40 includes an acquisition unit 411, a core tag generation unit 412, an encrypted tag generation unit 413, and an output unit 414, as functional components. Functions of the acquisition unit 411, the core tag generation unit 412, the encrypted tag generation unit 413, and the output unit 414 are realized by software.

The storage 43 stores a program for realizing functions of the acquisition unit 411, the core tag generation unit 412, the encrypted tag generation unit 413, and the output unit 414. This program is read into the memory 42 by the processor 41 and executed by the processor 41. Thus, functions of the acquisition unit 411, the core tag generation unit 412, the encrypted tag generation unit 413, and the output unit 414 are realized.

In addition, the storage 43 realizes a function of a key storage unit 431.

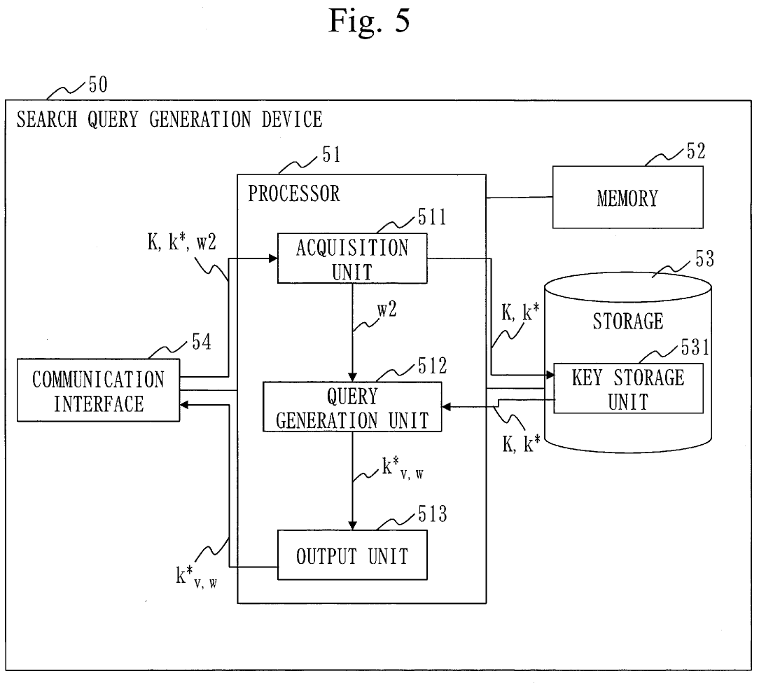

With reference to FIG. 5, a configuration of the search query generation device 50 according to the first embodiment will be described.

The search query generation device 50 is a computer.

The search query generation device 50 includes hardware of a processor 51, a memory 52, a storage 53, and a communication interface 54. The processor 51 is connected to other pieces of hardware via a signal line, and controls these other pieces of hardware.

The search query generation device 50 includes an acquisition unit 511, a query generation unit 512, and an output unit 513, as functional components. Functions of the acquisition unit 511, the query generation unit 512, and the output unit 513 are realized by software.

The storage 53 stores a program for realizing functions of the acquisition unit 511, the query generation unit 512, and the output unit 513. This program is read into the memory 52 by the processor 51 and executed by the processor 51. Thus, functions of the acquisition unit 511, the query generation unit 512, and the output unit 513 are realized.

Further, the storage 53 realizes the function with a key storage unit 531.

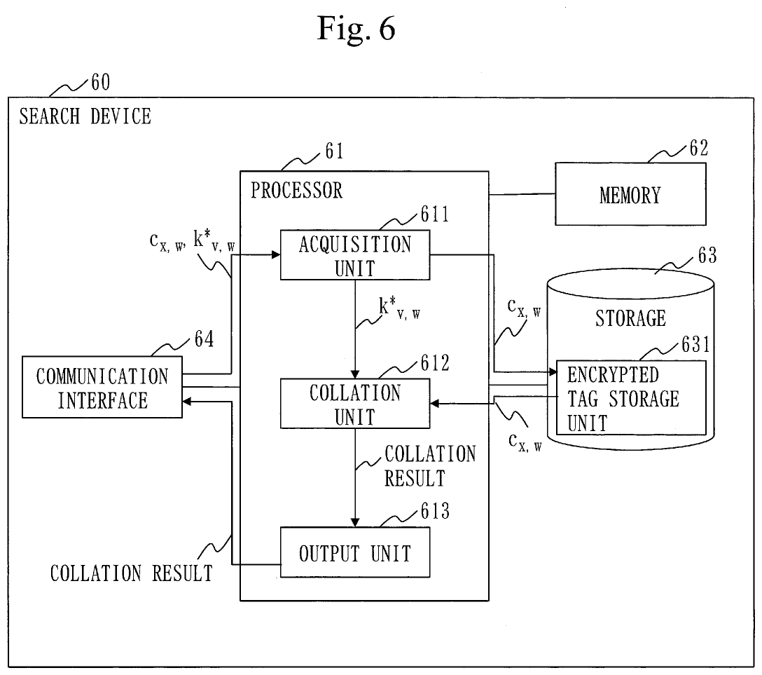

With reference to FIG. 6, a configuration of the search device 60 according to the first embodiment will be described.

The search device 60 is a computer.

The search device 60 includes hardware of a processor 61, a memory 62, a storage 63, and a communication interface 64. The processor 61 is connected to other pieces of hardware via a signal line, and controls these other pieces of hardware.

The search device 60 includes an acquisition unit 611, a collation unit 612, and an output unit 613, as functional components. Functions of the acquisition unit 611, the collation unit 612, and the output unit 613 are realized by software.

The storage 63 stores a program for realizing functions of the acquisition unit 611, the collation unit 612, and the output unit 613. This program is read into the memory 62 by the processor 61 and executed by the processor 61. Thus, functions of the acquisition unit 611, the collation unit 612, and the output unit 613 are realized.

In addition, the storage 63 realizes a function with an encrypted tag storage unit 631.

The processors 21, 31, 41, 51, and 61 are integrated circuits (ICs) that perform arithmetic processing. As a specific example, the processors 21, 31, 41, 51, and 61 are a central processing unit (CPU), a digital signal processor (DSP), or a graphics processing unit (GPU).

The memories 22, 32, 42, 52, and 62 are storage devices that temporarily store data. As a specific example, the memories 22, 32, 42, 52, and 62 are static random access memory (SRAM) or a dynamic random access memory (DRAM).

The storages 23, 33, 43, 53, and 63 are storage devices that store data. As a specific example, the storages 23, 33, 43, 53, and 63 are a hard disk drive (HDD). In addition, the storages 23, 33, 43, 53, and 63 may be a portable storage medium such as a secure digital (SD) memory card, a compact flash (CF), a NAND flash, a flexible disk, an optical disk, a compact disk, a Blu-Ray (registered trademark) disk, or a digital versatile disk (DVD).

The communication interfaces 24, 34, 44, 54, and 64 are interfaces to communicate with external devices. As a specific example, the communication interfaces 24, 34, 44, 54, and 64 are ports of Ethernet (registered trademark), a universal serial bus (USB), or a high-definition multimedia interface (HDMI, registered trademark).

In FIG. 2, only one processor 21 is illustrated. However, the master key generation device 20 may include a plurality of processors substituting for the processor 21. Similarly, the user key generation device 30 may include a plurality of processors substituting for the processor 31, the encrypted tag generation device 40 may include a plurality of processors substituting for the processor 41, and the search query generation device 50 may include a plurality of processors substituting for the processor 51.

Similarly, the search device 60 may include a plurality of processors substituting for the processor 61. These plurality of processors share execution of a program for realizing a function of each functional component. Similarly to the processors 21, 31, 41, 51, and 61, each processor is an IC that performs arithmetic processing.

***Description of Operation***

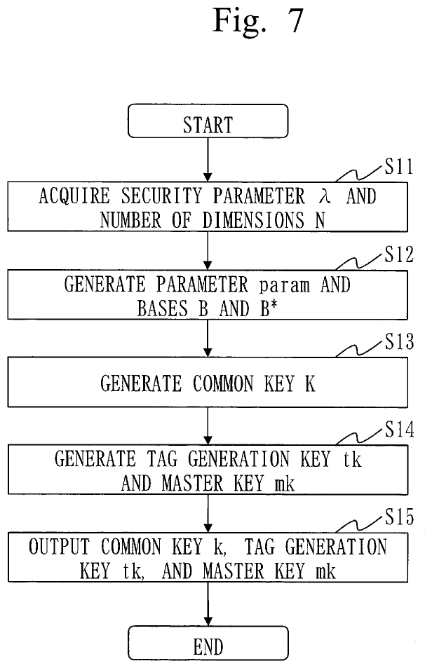

With reference to FIG. 7, an operation of the master key generation device 20 according to the first embodiment will be described.

The operation of the master key generation device 20 according to the first embodiment corresponds to a master key generation method according to the first embodiment. Further, the operation of the master key generation device 20 according to the first embodiment corresponds to processing of a master key generation program according to the first embodiment.

(Step S11: Acquisition Process)

The acquisition unit 211 acquires a security parameter λ and a number of dimensions N.

Specifically, the acquisition unit 211 accepts the security parameter λ and the number of dimensions N that are inputted by an administrator or the like of the master key generation device 20, via the communication interface 24. The acquisition unit 211 writes the security parameter λ and the number of dimensions N into the memory 22. The security parameter λ is a value to be determined in accordance with required safety. The number of dimensions N is a value to be determined depending on required safety, contents of access control desired to be realized, and the like, and is an integer of 3 or more as a specific example.

(Step S12: Basis Generation Process)

The master key generation unit 212 generates a parameter param and a basis B and a basis B* that are orthonormal bases.

Specifically, the master key generation unit 212 reads the security parameter λ and the number of dimensions N from the memory 22. The master key generation unit 212 takes as input the security parameter λ and the number of dimensions N, and generates the parameter param and the basis B and the basis B* as represented in Formula 16. The master key generation unit 212 writes the generated parameter param and basis B and basis B* into the memory 22.

$${𝒢}_{ob} ( {1}^{λ} , N ) \text{:} \\ {param}_{𝔾} := ( q , 𝔾 , {𝔾}_{T} , g , e ) {←}^{R} {𝒢}_{bpg} ( {1}^{λ} ) \\ ψ {←}^{⋃} {𝔽}_{q}^{x} , {g}_{T} := {e ( G , G )}^{ψ} , \\ {param}_{𝕍} := ( q , {𝕍}_{t} , {𝔾}_{T} , 𝔸 , e ) {←}^{R} {dpvs}_{} ( {1}^{λ} , {N}_{t} , {param}_{𝔾} ) , \\ X := ( \begin{matrix}{{X}^{}}_{1} \\ ⋮ \\ {{X}^{}}_{N}\end{matrix} ) := {( {X}_{i , j} )}_{i , j} {←}^{⋃} GL ( N , 𝔽q ) , \\ ( \begin{matrix}{{ϑ}_{1}}^{} \\ ⋮ \\ {{ϑ}_{N}}^{}\end{matrix} ) := ( {ϑ}_{i , j} ) i , j := ψ \cdot {( {X}^{T} )}^{- 1} , \\ {b}_{i} := {\sum }_{j = 1}^{N} {X}_{i , j} {a}_{j} for i = 1 , … , N , 𝔹 := ( {b}_{1} , … . {b}_{N} ) , \\ {b}_{i} := {\sum }_{j = 1}^{N} {ϑ}_{i , j} {a}_{j} for i = 1 , … , N , {𝔹}^{*} := ( {b}_{1}^{*} , … . {b}_{N}^{*} ) , \\ param := ( {param}_{𝕍} , {g}_{T} ) , \\ return ( param , 𝔹 , {𝔹}^{*} ) . \qquad [ Formula 16 ]$$

An algorithm G_{bpg} is an algorithm for generating a target bilinear pairing group (q, G, G_{T}, g, e). The target bilinear pairing group (q, G, G_{T}, g, e) is a set of a prime number q, a cyclic additive group G of the order q, a cyclic multiplicative group G_{T} of the order q, g≠0 ∈ G, and non-degenerate bilinear pairing e: G×G→G_{T}.

An algorithm G_{dpvs} is an algorithm for generating a dual pairing vector space (q, V, G_{T}, A, e). The dual pairing vector space (q, V, G_{T}, A, e) is a set of a prime number q, an N-dimensional vector space V constituted by a direct product of the group G, a cyclic group G_{T} of the order q, a standard basis A of a space V:=(a₁, . . . , a_{N}).

(Step S13: Common Key Generation Process)

The master key generation unit 212 randomly generates a common key K←{0, 1}^{λ}. The master key generation unit 212 writes the generated common key K into the memory 22.

(Step S14: Master Key Generation Process)

The master key generation unit 212 generates a tag generation key tk and a master key mk.

Specifically, the master key generation unit 212 reads the parameter param and the basis B from the memory 22. The master key generation unit 212 writes the read parameter param and basis B into the memory 22, as the tag generation key tk. Further, the master key generation unit 212 reads the parameter param and the basis B* from the memory 22. The master key generation unit 212 writes the read parameter param and basis B* into the memory 22, as the master key mk.

(Step S15: Output Process)

The output unit 213 outputs the common key K, the tag generation key tk, and the master key mk to the key storage unit 231.

Specifically, the output unit 213 reads the common key K, the tag generation key tk, and the master key mk from the memory 22. The output unit 213 writes the read common key K, tag generation key tk, and master key mk into the key storage unit 231. Further, the output unit 213 transmits the master key ink to the user key generation device 30 via the communication interface 24, transmits the common key K and the tag generation key tk to the encrypted tag generation device 40, and transmits the common key K to the search query generation device 50.

When transmitting the common key K, the tag generation key tk, and the master key mk, the output unit 213 is not to allow the common key K, the tag generation key tk, and the master key mk to be leaked to others, by a method such as encrypting with an existing encryption method. Meanwhile, instead of transmitting the common key K, the tag generation key tk, and the master key mk via the communication interface 24 through the network 70, the output unit 213 may write into a portable storage medium. Then, the portable storage medium may be sent by mail to the user key generation device 30, the encrypted tag generation device 40, and the search query generation device 50.

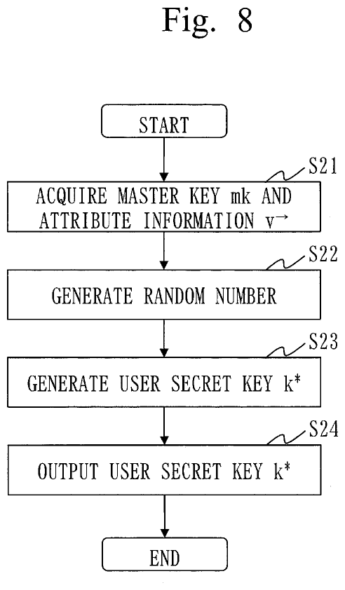

With reference to FIG. 8, an operation of the user key generation device 30 according to the first embodiment will be described.

The operation of the user key generation device 30 according to the first embodiment corresponds to a user key generation method according to the first embodiment. Further, the operation of the user key generation device 30 according to the first embodiment corresponds to processing of a user key generation program according to the first embodiment.

(Step S21: Acquisition Process)

The acquisition unit 311 acquires the master key mk and attribute information v\vec{ } of a user.

Specifically, the acquisition unit 311 receives the master key mk transmitted in step S15 of FIG. 7, via the communication interface 34. The acquisition unit 311 writes the received master key mk into the memory 32 and the key storage unit 331. Note that, in a case where the master key mk has already been stored in the key storage unit 331, the acquisition unit 311 reads the master key mk from the key storage unit 331 and writes into the memory 32.

In addition, the acquisition unit 311 accepts the attribute information v\vec{ } of the user inputted by the administrator or the like of the user key generation device 30, via the communication interface 34. The attribute information v\vec{ } of the user is expressed as an n-dimensional vector over the finite field F_{q}. The attribute information v\vec{ } is a vector other than a vector whose elements are all zeros. The acquisition unit 311 writes the accepted attribute information v\vec{ } into the memory 32. The attribute information v\vec{ } indicates attributes of a user such as a section to which the user belongs and a user's position.

(Step S22: Random Number Generation Process)

The user key generation unit 312 generates a random number σ ∈ F_{q} and a random number if η\vec{ } ∈ F_{q}^{L}. The user key generation unit 312 writes the generated random number σ and random number η\vec{ } into the memory 32.

(Step S23: User Key Generation Process)

The user key generation unit 312 sets the attribute information v\vec{ } to the master key mk, to generate a user key k*.

Specifically, the user key generation unit 312 reads the master key mk, the attribute information v\vec{ }, the random number σ, and the random number η\vec{ } if from the memory 32. Using the master key ink, the attribute information v\vec{ }, the random number σ, and the random number η\vec{ }, the user key generation unit 312 generates the user key k* as represented in Formula 17. The user key generation unit 312 writes the generated user key k* into the memory 32.

k*:=(σ\vec{v}, 0^{m}, \vec{n}, 0^{k} [symbol] [Formula 17]

In addition, 0^{m} means m pieces of 0. Similarly, 0^{k} means k pieces of 0. m and k are integers of 0 or more.

(Step S24: Output Process)

The output unit 313 outputs the user key k*.

Specifically, the output unit 313 reads the user key k* from the memory 32. The output unit 313 transmits the read user key k* to the search query generation device 50, via the communication interface 34. The output unit 313 may write the user key k* into a portable storage medium, and the portable storage medium may be sent to the search query generation device 50.

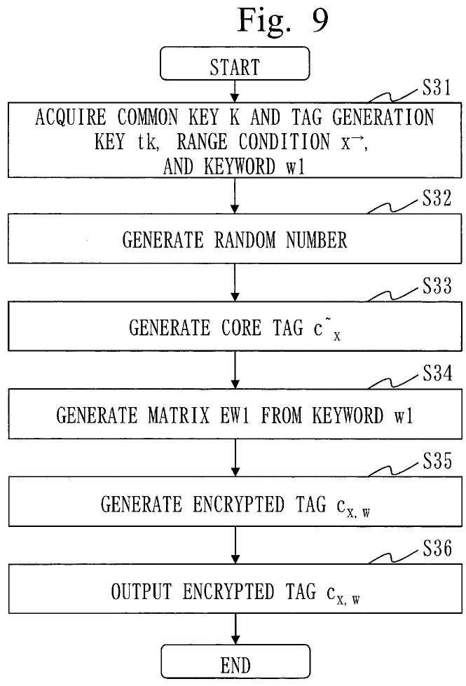

With reference to FIG. 9, an operation of the encrypted tag generation device 40 according to the first embodiment will be described.

The operation of the encrypted tag generation device 40 according to the first embodiment corresponds to an encrypted tag generation method according to the first embodiment. Further, the operation of the encrypted tag generation device 40 according to the first embodiment corresponds to processing of an encrypted tag generation program according to the first embodiment.

(Step S31: Acquisition Process)

The acquisition unit 411 acquires the common key K and the tag generation key tk, a range condition x\vec{ }, and a keyword w1.

Specifically, the acquisition unit 411 receives the common key K and the tag generation key tk transmitted in step S15 of FIG. 7, via the communication interface 44. The acquisition unit 411 writes the received common key K and tag generation key tk into the memory 42 and the key storage unit 431. Note that, in a case where the common key K and the tag generation key tk have already been stored in the key storage unit 431, the acquisition unit 411 reads the common key K and the tag generation key tk from the key storage unit 431, and writes into the memory 42.

In addition, the acquisition unit 411 accepts the range condition x\vec{ } and the keyword w1 inputted by a user or the like of the encrypted tag generation device 40, via the communication interface 44. The range condition is expressed as an n-dimensional vector over the finite field F_{q}. The range condition x\vec{ } is a vector other than a vector whose elements are all zeros. The range condition x\vec{ } indicates a range for permitting searching, and indicates a department, a position in an organization, and the like to which searching is permitted. The keyword w1 is a bit string of any number of bits. The acquisition unit 411 writes the accepted range condition x\vec{ } and keyword w1 into the memory 42.

(Step S32: Random Number Generation Process)

The core tag generation unit 412 generates a random number ω ∈ F_{q} and a random number φ\vec{ } ∈ F_{q}^{k}. The core tag generation unit 412 writes the generated random number ω and random number φ\vec{ } into the memory 42.

(Step S33: Core Tag Generation Process)

The core tag generation unit 412 generates a core tag c\tilde{ }ₓ by encrypting the range condition x\vec{ } indicating a range for permitting searching with the tag generation key tk, which is a key for generating an encrypted tag c_{x, w}.

Specifically, the core tag generation unit 412 reads the tag generation key tk, the range condition x\vec{ }, the random number ω, and the random number φ\vec{ } from the memory 42. The core tag generation unit 412 generates the core tag c\tilde{ }ₓ, which is a vector over the basis B as represented in Formula 18, by using the tag generation key tk, the range condition x\vec{ }, the random number ω, and the random number φ\vec{ }. The core tag generation unit 412 writes the generated core tag c\tilde{ }ₓ into the memory 42.

c\tilde{ }ₓ:=(ω\vec{x}, 0^{m}, 0^{L}, \vec{ϕ} [symbol] [Formula 18]

In addition, 0^{L} means L pieces of 0. L is an integer of 0 or more.

(Step S34: Encoding Process)

The encrypted tag generation unit 413 generates a matrix EW1, which is encode information in which the keyword w1 is encoded.

Specifically, the encrypted tag generation unit 413 reads the common key K and the keyword w1 from the memory 42. The encrypted tag generation unit 413 calculates an encoding function H with the common key K and the keyword w1 as inputs, to generate the matrix EW1 ∈ F_{q}^{N×N}, which is a square matrix of N rows and N columns. The encrypted tag generation unit 413 writes the generated matrix EW1 into the memory 42.

As a specific example, the encoding function H is a function of repeatedly executing a hash function. For example, the encoding function H inputs the common key K, the keyword w1, and a value “1” to the hash function, to generate a first row component of a matrix EW. Further, the encoding function H inputs the common key K, the keyword w1, and a value “2” to the hash function, to generate a second row component of the matrix EW. As described above, the encoding function H is a function of calculating a component of each row of the matrix EW, with the common key K, the keyword w1, and a value corresponding to the row as inputs of the hash function.

(Step S35: Encrypted Tag Generation Process)

The encrypted tag generation unit 413 generates the encrypted tag c_{x, w} in which the keyword w1 is set, by converting the core tag c\tilde{ }ₓ by the matrix EW1, which is encode information in which the keyword w1 for searching is encoded.

Specifically, the encrypted tag generation unit 413 reads the core tag c\tilde{ }ₓ and the matrix EW1 from the memory 42. The encrypted tag generation unit 413 calculates a matrix product of the core tag c\tilde{ }ₓ and the matrix EW1, to generate the encrypted tag c_{x, w} as represented in Formula 19.

c_{x,w}:=c\tilde{ }ₓ·(EW1) [Formula 19]

That is, the encrypted tag generation unit 413 generates the encrypted tag c_{x, w} by calculating the matrix product of the core tag c\tilde{ }ₓ and the matrix EW1 to convert the basis B of the core tag c\tilde{ }ₓ. The encrypted tag generation unit 413 writes the generated encrypted tag c_{x, w} into the memory 42.

(Step S36: Output Process)

The output unit 414 outputs the encrypted tag c_{x, w}.

Specifically, the output unit 414 reads the encrypted tag c_{x, w} from the memory 42. The output unit 414 transmits the read encrypted tag c_{x, w} to the search device 60 via the communication interface 44. The output unit 414 may write the encrypted tag c_{x, w} into a portable storage medium, and the portable storage medium may be sent to the search device 60.

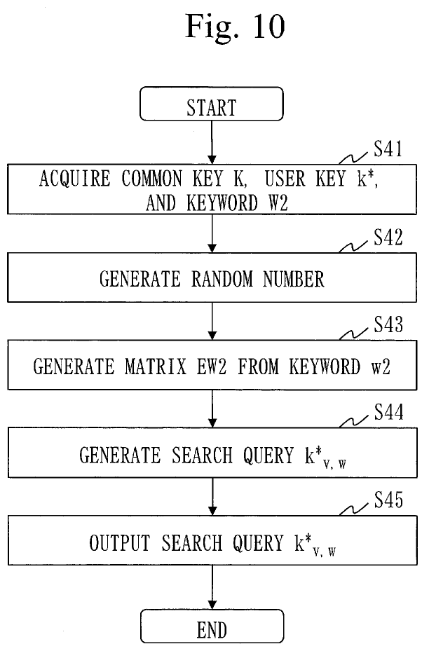

With reference to FIG. 10, an operation of the search query generation device 50 according to the first embodiment will be described.

The operation of the search query generation device 50 according to the first embodiment corresponds to a search query generation method according to the first embodiment. Further, the operation of the search query generation device 50 according to the first embodiment corresponds to processing of a search query generation program according to the first embodiment.

(Step S41: Acquisition Process)

The acquisition unit 511 acquires the common key K, the user key k*, and a keyword w2.

Specifically, the acquisition unit 511 receives the common key K transmitted in step S15 of FIG. 7, via the communication interface 54. The acquisition unit 511 writes the received common key K into the memory 52 and the key storage unit 531. Note that, in a case where the common key K has already been stored in the key storage unit 531, the acquisition unit 511 reads the common key K from the key storage unit 531 and writes into the memory 52.

In addition, the acquisition unit 511 receives the user key k* transmitted in step S24 of FIG. 8, via the communication interface 54. The acquisition unit 511 writes the received user key k* into the memory 52 and the key storage unit 531. Note that, in a case where the user key k* has already been stored in the key storage unit 531, the acquisition unit 511 reads the user key k* from the key storage unit 531 and writes into the memory 52.

In addition, the acquisition unit 511 accepts the keyword w2 inputted by a user or the like of the search query generation device 50, via the communication interface 54. The keyword w2 is a bit string of any number of bits. The acquisition unit 411 writes the accepted keyword w2 into the memory 52.

(Step S42: Random Number Generation Process)

The query generation unit 512 generates a random number r ∈ F_{q}. The query generation unit 512 writes the generated random number r into the memory 52.

(Step S43: Encoding Process)

The query generation unit 512 generates a matrix EW2, which is the encode information in which the keyword w2 is encoded.

Specifically, the query generation unit 512 reads the common key K and the keyword w2 from the memory 52. The query generation unit 512 calculates the encoding function H with the common key K and the keyword w2 as inputs, to generate the matrix EW2 ∈ F_{q}^{N×N}, which is a square matrix of N rows and N columns. The query generation unit 512 writes the generated matrix EW2 into the memory 52.

Note that the same encoding function H as that in step S34 of FIG. 9 is used.

(Step S44: Query Generation Process)

The query generation unit 512 generates a search query k*_{v, w} in which the keyword w2 is set, by converting the user key k* in which an attribute of the user is set, by the matrix EW2, which is the encode information in which the keyword w2 for searching is encoded.

Specifically, the query generation unit 512 reads the user key k*, the matrix EW2, and the random number r from the memory 52. The encrypted tag generation unit 413 generates the search query k*_{v, w} by calculating a matrix product of the user key k* and an inverse matrix of a matrix obtained by transposing the matrix EW2 as represented in Formula 20.

k*_{v,w}:=rk*·(EW2^{T})⁻¹ [Formula 20]

That is, the query generation unit 512 generates the search query k*_{v, w} by calculating the matrix product of the user key k* and the inverse matrix of the matrix obtained by transposing the matrix EW2, to convert the basis B* of the user key k*. The query generation unit 512 writes the generated search query k*_{v, w} into the memory 52.

(Step S45: Output Process)

The output unit 513 outputs the search query k_{v, w}.

Specifically, the output unit 513 reads the search query k*_{v, w} from the memory 52. The output unit 513 transmits the read search query k*_{v, w} to the search device 60 via the communication interface 54. The output unit 513 may write the search query k*_{v, w} into a portable storage medium, and the portable storage medium may be sent to the search device 60.

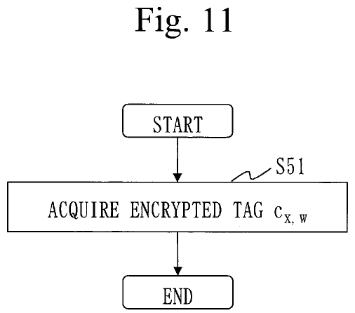

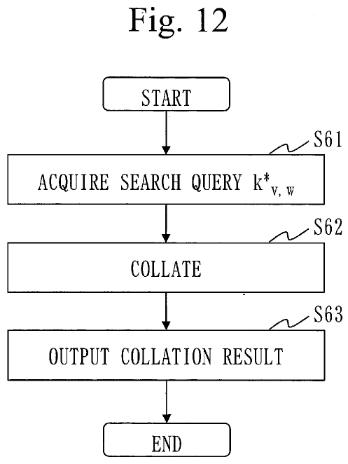

With reference to FIGS. 11 and 12, an operation of the search device 60 according to the first embodiment will be described.

The operation of the search device 60 according to the first embodiment corresponds to a search method according to the first embodiment. Further, the operation of the search device 60 according to the first embodiment corresponds to processing of a search program according to the first embodiment.

The operation of the search device 60 according to the first embodiment is divided into an encrypted tag storage process and an encrypted tag search process.

With reference to FIG. 11, the encrypted tag storage process according to the first embodiment will be described.

(Step S51: Acquisition Process)

The acquisition unit 611 acquires the encrypted tag c_{x, w}.

Specifically, the acquisition unit 611 receives the encrypted tag c_{x, w} transmitted in step S36 of FIG. 9, via the communication interface 64. The acquisition unit 611 writes the received encrypted tag c_{x, w} into the encrypted tag storage unit 631.

The transmitted encrypted tag c_{x, w} is written into the encrypted tag storage unit 631 every time the encrypted tag c_{x, w} is transmitted in step S36 of FIG. 9, whereby a plurality of encrypted tags c_{x, w} are stored in the encrypted, tag storage unit 631.

With reference to FIG. 12, the encrypted tag search process according to the first embodiment will be described.

(Step S61: Acquisition Process)

The acquisition unit 611 acquires the search query k*_{v, w}.

Specifically, the acquisition unit 611 receives the search query k*_{v, w} transmitted in step S45 of FIG. 10, via the communication interface 64. The acquisition unit 611 writes the received search query k*_{v, w} into the memory 62.

(Step S62: Collation Process)

The collation unit 612 collates each encrypted tag c_{x, w} stored in the encrypted tag storage unit 631 with the search query k*_{v, w}, and extracts the encrypted tag c_{x, w} corresponding to the search query k*_{v, w}.

Specifically, the collation unit 612 reads the search query k*_{v, w} from the memory 62. The collation unit 612 performs a pairing operation represented in Formula 21 for each encrypted tag c_{x, w} stored in the encrypted tag storage unit 631 and the read search query k*_{v, w}.

P:=e(c_{x,w},k*_{v,w}) [Formula 21]

The collation unit 612 determines that the encrypted tag c_{x, w} to be computed corresponds to the search query k*_{v, w} when a value P obtained as a result of the pairing operation is 1, and determines that the encrypted tag c_{x, w} to be computed does not correspond to the search query k*_{v, w} when the value P obtained as a result of the pairing operation is not 1.

(Step S63: Output Process)

The output unit 613 outputs a collation result.

More specifically, the output unit 613 transmits identification information of the encrypted tag c_{x, w} determined to correspond to the search query k*_{v, w}, via the communication interface 64, to the search query generation device 50 of the transmission source of the search query k*_{v, w} received in step S61. Alternatively, via the communication interface 64, the output unit 613 transmits whether or not there is the encrypted tag c_{x, w} determined to correspond to the search query k*_{v, w} to the search query generation device 50 of the transmission source of the search query k*_{v, w} received in step S61.

### Effect of First Embodiment

As described above, in the searchable encryption system 10 according to the first embodiment, the encrypted tag generation device 40 generates the encrypted tag c_{x, w} by converting the core tag c\tilde{ }ₓ obtained by encrypting the range condition x\vec{ }, by the matrix EW1, which is the encode information in which the keyword w1 is encoded. In addition, the search query generation device 50 generates the search query k*_{v, w} by converting the user key k* to which the attribute information v\vec{ } is set, by the matrix EW2, which is the encode information in which the keyword w2 is encoded.

More specifically, by converting the basis B of the core tag c\tilde{ }ₓ by the matrix EW1, the encrypted tag generation device 40 generates the encrypted tag c_{x, w} in which a keyword is set, without increasing the number of elements of the core tag c\tilde{ }ₓ. Further, by converting the basis B* of the user key k* by the matrix EW2, the search query generation device 50 generates the search query k*_{v,w} in which a keyword is set, without increasing the number of elements of the user key k*.

Therefore, as compared with an encrypted tag having elements each corresponding to range information and a keyword, and a search query having elements each corresponding to attribute information and a keyword as in the conventional one, it is possible to generate the encrypted tag c_{x, w} and the search query k*_{v, w} having fewer elements. As a result, it is possible to reduce the number of computations of the pairing operation in step S63 in FIG. 12. Reducing the number of pairing operations shortens a processing time required to collate the encrypted tag c_{x, w} with the search query k*_{v, w}, and increases a search speed.

Further, in the searchable encryption system 10 according to the first embodiment, the range information is set for the encrypted tag c_{x, w}, while the attribute information is set for the search query k*_{v, w} as in the conventional one. Therefore, flexible access control can be realized.

***Other Configuration***

<Modification 1>

In the first embodiment, the functional components of the master key generation device 20, the user key generation device 30, the encrypted tag generation device 40, the search query generation device 50, and the search device 60 are realized by software. However, as Modification 1, the functional components may be realized by hardware. With regard to Modification 1, points different from the first embodiment will be described.

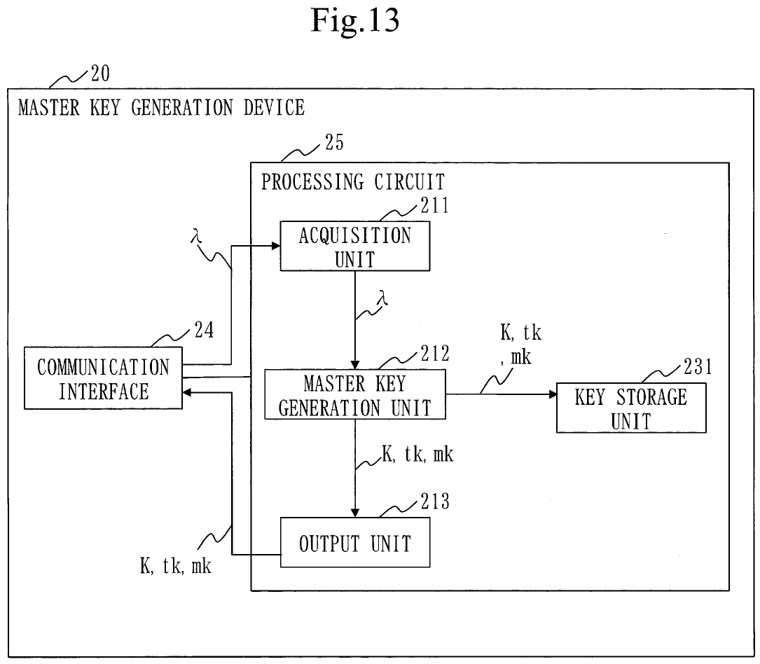

With reference to FIG. 13, a configuration of a master key generation device 20 according to Modification 1 will be described.

In a case where a function is realized by hardware, the master key generation device 20 includes a processing circuit 25, instead of the processor 21, the memory 22, and the storage 23. The processing circuit 25 is a dedicated electronic circuit to realize functional components of the master key generation device 20 and functions of the memory 22 and the storage 23.

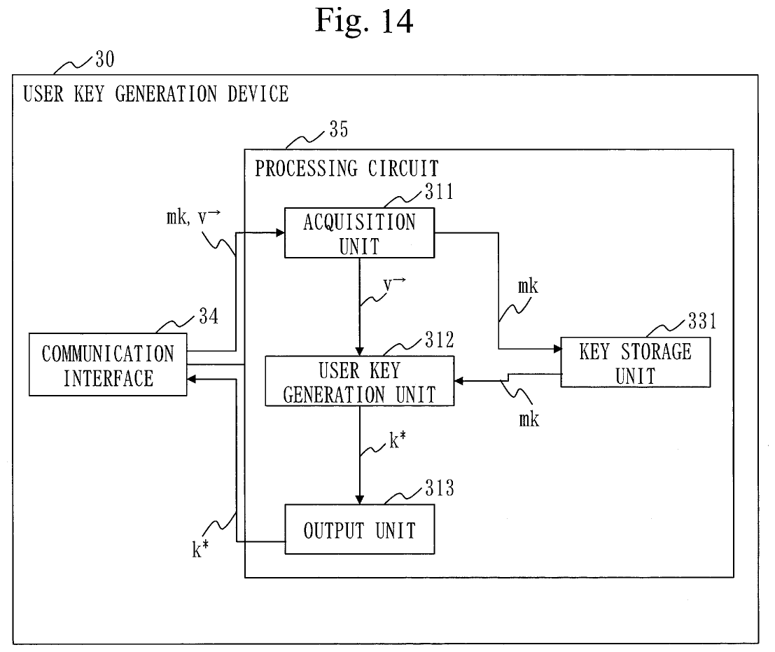

With reference to FIG. 14, a configuration of a user key generation device 30 according to Modification 1 will be described.

In a case where a function is realized by hardware, the user key generation device 30 includes a processing circuit 35, instead of the processor 31, the memory 32, and the storage 33. The processing circuit 35 is a dedicated electronic circuit to realize functional components of the user key generation device 30 and functions of the memory 32 and the storage 33.

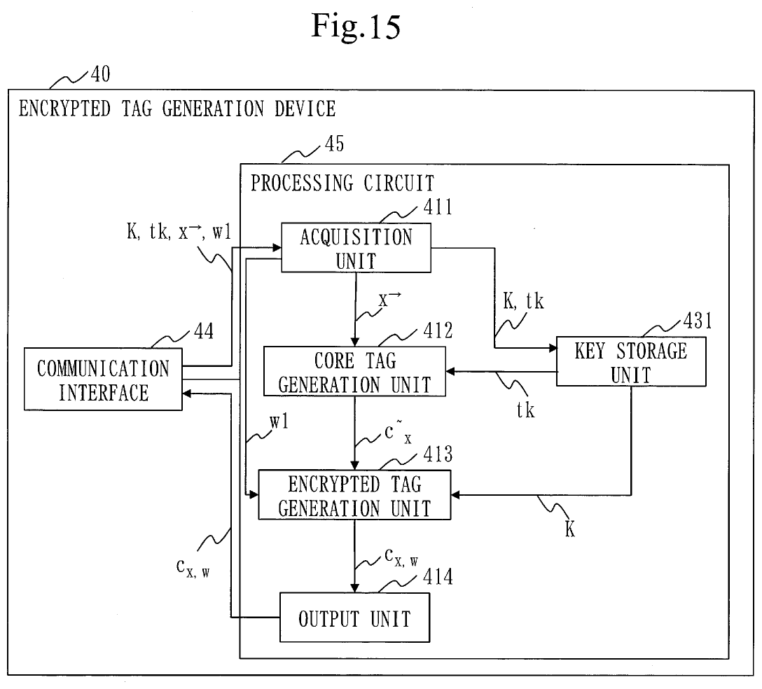

With reference to FIG. 15, a configuration of an encrypted tag generation device 40 according to Modification 1 will be described.

In a case where a function is realized by hardware, the encrypted tag generation device 40 includes a processing circuit 45, instead of the processor 41, the memory 42, and the storage 43. The processing circuit 45 is a dedicated electronic circuit to realize functional components of the encrypted tag generation device 40 and functions of the memory 42 and the storage 43.

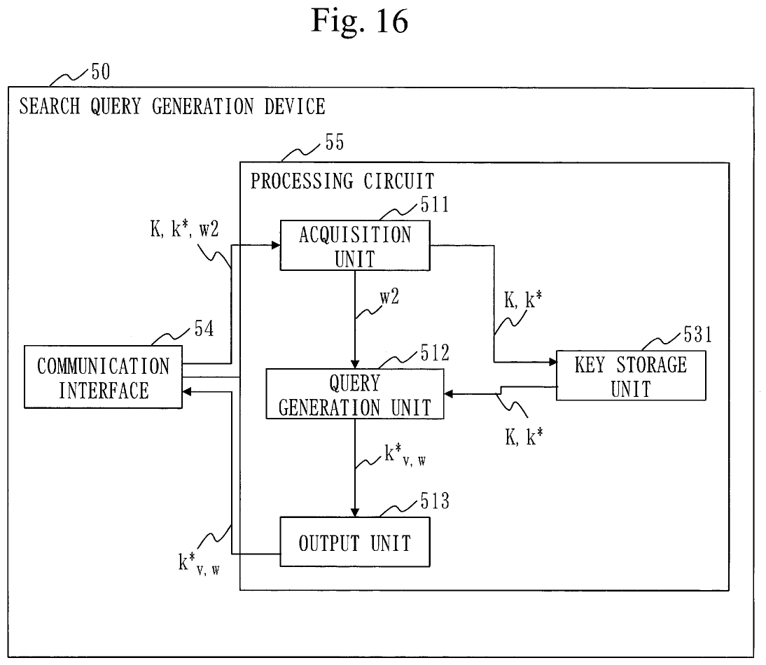

With reference to FIG. 16, a configuration of a search query generation device 50 according to Modification 1 will be described.

In a case where a function is realized by hardware, the search query generation device 50 includes a processing circuit 55 instead of the processor 51, the memory 52, and the storage 53. The processing circuit 55 is a dedicated electronic circuit to realize functional components of the search query generation device 50 and functions of the memory 52 and the storage 53.

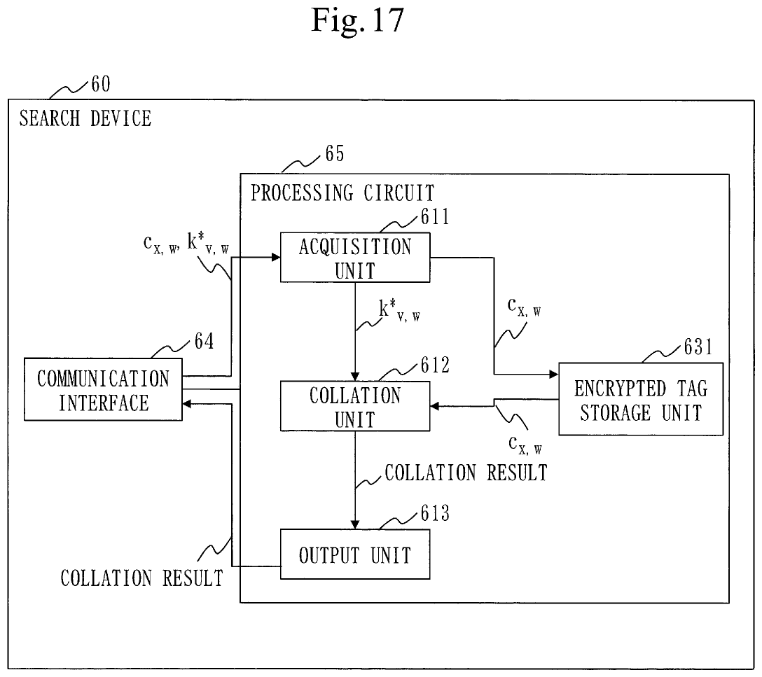

With reference to FIG. 17, a configuration of a search device 60 according to Modification 1 will be described.

In a case where a function is realized by hardware, the search device 60 includes a processing circuit 65 instead of the processor 61, the memory 62, and the storage 63. The processing circuit 65 is a dedicated electronic circuit to realize functional components of the search device 60 and functions of the memory 62 and the storage 63.

For the processing circuits 25, 35, 45, 55, and 65, a single circuit, a composite circuit, a programmed processor, a parallel programmed processor, a logic IC, a gate array (GA), an application specific integrated circuit (ASIC), or a field-programmable gate array (FPGA) is assumed.

A function of each functional component of the master key generation device 20 may be realized by one processing circuit 25, or a function of each functional component may be distributed to a plurality of processing circuits 25 to be realized. Similarly, for each of the user key generation device 30, the encrypted tag generation device 40, the search query generation device 50, and the search device 60, a function of each functional component may be realized by one processing circuit 35, 45, 55, or 65, or a function of each functional component may be distributed to a plurality of processing circuits 35, 45, 55, or 65 to be realized.

<Modification 2>

In Modification 2, some functions may be realized by hardware, while other functions may be realized by software. That is, in each functional component, some functions may be realized by hardware, while other functions may be realized by software.

The processors 21, 31, 41, 51, and 61, the memories 22, 32, 42, 52, and 62, the storages 23, 33, 43, 53, and 63, and the processing circuits 25, 35, 45, 55, and 65 are collectively referred to as “processing circuitry”. That is, functions of each functional component are realized by the processing circuitry.

### REFERENCE SIGNS LIST

10: searchable encryption system, 20: master key generation device, 21: processor, 22: memory, 23: storage, 24: communication interface, 25: processing circuit, 211: acquisition unit, 212: master key generation unit, 213: output unit, 231: key storage unit, 30: user key generation device, 31: processor, 32: memory, 33: storage, 34: communication interface, 35: processing circuit, 311: acquisition unit, 312: user key generation unit, 313: output unit, 331: key storage unit, 40: encrypted tag generation device, 41: processor, 42: memory, 43: storage, 44: communication interface, 45: processing circuit, 411: acquisition unit, 412: core tag generation unit, 413: encrypted tag generation unit, 414: output unit, 431: key storage unit, 50: search query generation device, 51: processor, 52: memory, 53: storage, 54: communication interface, 55: processing circuit, 511: acquisition unit, 512: query generation unit, 513: output unit, 531: key storage unit, 60: search device, 61: processor, 62: memory, 63: storage, 64: communication interface, 65: processing circuit, 611: acquisition unit, 612: collation unit, 613: output unit, 631: encrypted tag storage, 70: network.

1. An encrypted tag generation device comprising:
processing circuitry to:
generate a core tag by encrypting a range condition indicating a range to permit searching; and
generate an encrypted tag in which a keyword for searching is set, by converting the generated core tag with use of encode information in which the keyword is encoded.

2. The encrypted tag generation device according to claim 1, wherein
the core tag is a vector over a basis B, and
the processing circuitry generates the encrypted tag by converting the basis B of the core tag with use of the encode information.

3. The encrypted tag generation device according to claim 2, wherein
the processing circuitry generates a matrix that is the encode information, and calculates a product of the core tag and the matrix to convert the basis B.

4. The encrypted tag generation device according to claim 3, wherein
the processing circuitry generates a square matrix that is the encode information.

5. A search query generation device comprising:
processing circuitry to generate a search query in which a keyword for searching is set, by converting a user key in which a user attribute is set, with use of encode information in which the keyword is encoded.

6. The search query generation device according to claim 5, wherein
the user key is a vector over a basis B*, and
the processing circuitry generates the search query by converting the basis B* of the user key with use of the encode information.

7. The search query generation device according to claim 6, wherein
the processing circuitry generates a matrix that is the encode information, and calculates a product of the user key and an inverse matrix of a matrix obtained by transposing the matrix to convert the basis B*.

8. The search query generation device according to claim 7, wherein
the processing circuitry generates a square matrix that is the encode information.

9. A searchable encryption system comprising an encrypted tag generation device and a search query generation device, wherein
the encrypted tag generation device includes
processing circuitry to:
generate a core tag by encrypting a range condition indicating a range to permit searching, and
generate an encrypted tag in which a keyword for searching is set, by converting the generated core tag with use of encode information in which the keyword is encoded, and
the search query generation device includes
processing circuitry to generate a search query in which a keyword for searching is set, by converting a user key in which a user attribute is set, with use of encode information in which the keyword is encoded.
